(19) United States
(12) Patent Application Publication
(10) Pub. No.: US 2025/0141369 A1
(43) Pub. Date: May 1, 2025

(54) MULTI-PHASE INVERTER

(71) Applicants: Infineon Technologies AG, Neubiberg (DE); Mazda Motor Corporation, Hiroshima (JP)

(72) Inventors: Rodrigo Da Silva, Unterhaching (DE); Radovan Vuletic, München (DE); Akihito Furukawa, Hiroshima (JP); Kazuya Kotani, Hiroshima (JP); Ikuo Usami, Hiroshima (JP); Seiyo Hirano, Hiroshima (JP)

(21) Appl. No.: 18/496,587

(22) Filed: Oct. 27, 2023

(51) Int. Cl. H02M 7/5395; H02M 1/00; H02M 1/088; H02M 7/487

(52) U.S. Cl. CPC H02M 7/5395; H02M 1/0095; H02M 1/088; H02M 7/487

(57) ABSTRACT

In accordance with an embodiment, a circuit includes: a battery monitoring circuit configured to monitor a positive supply voltage and a negative supply voltage with respect to a neutral node; an inverter configured to provide a plurality of modulated phase voltages representing a reference voltage vector; and a space vector modulator configured to generate modulated drive signals for the inverter based on the reference voltage vector, where duty cycles of the modulated drive signals depend on the monitored positive supply voltage and the monitored negative supply voltage.

### TECHNICAL FIELD

The present disclosure relates to the field of electronic circuits, in particular to a multi-phase inverter.

### BACKGROUND

Multi-phase inverters are commonly used for driving synchronous or asynchronous motors. Such motors are also referred to as inverter-fed synchronous/asynchronous motors. Brushless DC motors (which are actually synchronous motors in which the excitation field is generated by permanent magnets) may also be driven using inverters. Multi-phase inverters often have three phases but can also have two, four or more phases.

One common type of inverter is the so-called Active Neutral Point Clamped (ANPC) inverter. ANPC inverters are multi-level inverters which can generate modulated phase voltages that can assume three or more different voltage levels. For example, in a three-level inverter each phase voltage can assume either the voltage level of the positive supply voltage, zero (voltage level of the neutral point) or the voltage level of the negative supply voltage. For battery-supplied inverters, the neutral point is usually generated/defined by dividing the battery voltage U_{DC} (often referred to as DC bus voltage) into to equal voltages using a capacitive voltage divider. In this manner a symmetrical bipolar supply is provided, wherein the positive supply voltage is U_{DC}/2, the voltage of the neutral point is—per definition—zero volts and the negative supply voltage is −U_{DC}/2.

In some applications two batteries (or battery modules) are connected in series and the common circuit node, at which the batteries are connected, is used as neutral point. In such a situation, the bipolar supply may become unsymmetrical when the states of charge (SoC) of the two batteries are different. At the same time, the DC bus voltage U_{DC} is the sum of the battery voltages of the two batteries.

The inverters are usually driven by a plurality of pulse-width modulated (PWM) signals which are used to activate (switch on) and deactivate (switch off) the transistors of the inverter. Various suitable PWM schemes are as such known. However, in case of an unsymmetrical supply composed of two batteries (or battery modules) connected at the neutral point known PWM switching schemes may cause the battery with the lower SoC being discharged more than the battery with the higher SoC thus making the asymmetry of the bipolar supply worse.

Moreover, known algorithms used for generating the PWM signals assume the voltage supply being symmetric, and an operation with an unsymmetrical supply will introduce a systematic error.

### SUMMARY

A circuit is described herein which, in accordance to one embodiment, includes a battery monitoring circuit configured to monitor a positive supply voltage and a negative supply voltage with respect to a neutral node, an inverter configured to provide a plurality of modulated phase voltages representing a reference voltage vector, and a space vector modulator configured to generate modulated drive signals for the inverter based on the reference voltage vector. The drive signals have duty cycles that depend on the monitored positive supply voltage and the monitored negative supply voltage.

Further, a corresponding method is described herein. In accordance with one embodiment, the method includes monitoring a positive and a negative supply voltage of an inverter with respect to a neutral node and generating—by a space vector modulator—modulated drive signals for the inverter based on a reference voltage vector. The duty cycles of the modulated drive signals are controlled dependent on the monitored positive supply voltage and the monitored negative supply voltage. The modulated drive signals are provided to the inverter thus causing the inverter to provide a plurality of modulated phase voltages representing the reference voltage vector.

Moreover, a three-level inverter system is described herein. In accordance with one embodiment, the system comprises a first power supply and a second power supply, which are connected at a neutral node and provide a positive and a negative supply voltage. The system further comprises a battery monitoring circuit configured to monitor the positive supply voltage and the negative supply voltage and an inverter that is supplied by the positive supply voltage and the negative supply voltage. A space vector modulator is configured to generate modulated drive signals for the inverter such that the positive supply voltage and the negative supply voltage are rebalanced or remain substantially balanced.

### BRIEF DESCRIPTION OF THE DRAWINGS

The invention can be better understood with reference to the following drawings and descriptions. The components in the figures are not necessarily to scale; instead emphasis is placed upon illustrating the principles of the invention. Moreover, in the figures, like reference numerals designate corresponding parts. In the drawings:

FIG. 1 is a block diagram illustrating one example of a control loop for controlling a three-phase synchronous motor using Space Vector Modulation.;

FIG. 2 is an exemplary block diagram illustrating a PWM modulator and an ANPC inverter which may be used for Space Vector modulation.

FIG. 3 illustrates one example of a three-level ANPC inverter with three phases.

FIG. 4 visualizes, in diagrams (a) to (d) the four different switching states of each inverter phase.

FIG. 5 shows a table including a plurality of sequences of inverter states which can be used to generate an arbitrary voltage vector.

FIG. 6 visualizes the different voltage vectors (space vectors) that may be achieved by the inverter states listed in the table of FIG. 5 for a symmetric power supply of the inverter.

FIG. 7 visualizes a specific modulation sequence.

FIG. 8 visualizes the modulation sequence of FIG. 7 modified in accordance with one embodiment.

FIG. 9 visualizes how the diagram of FIG. 6 is distorted for an inverter supplied by an unsymmetrical power supply.

FIGS. 10-12 illustrate the decomposition of the hexagon of the diagram of FIG. 6 for the purpose of determining a modulation sequence and the times associated with the inverter states of the determined sequence.

FIG. 13 visualizes a modulation sequence corresponding to the voltage vector in FIG. 11.

### DETAILED DESCRIPTION OF ILLUSTRATIVE EMBODIMENTS

Some embodiments of the present invention are directed to a method of operating an inverter, in a manner suitable for operation on asymmetrical supplies.

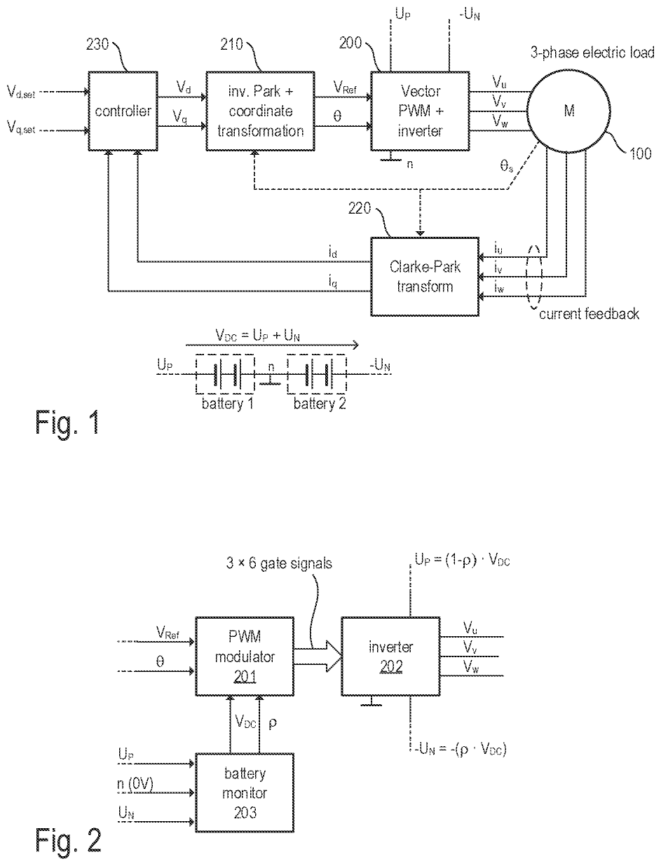

Before examples of PWM modulator and ANPC inverter are discussed in greater detail an exemplary application of Space Vector modulation is described with reference to FIG. 1, which is a block diagram illustrating one example of a control loop for controlling a three-phase synchronous motor 100, which is used as one illustrative example for a load supplied with a multi-phase voltage.

The motor 100 is driven using an inverter that is controlled using a space vector modulator. The functional block including the modulator and the inverter is labelled 200 in FIG. 1. In the present example, the space vector modulator receives a reference space vector that can be represented by amplitude V_{REF} and angle θ (polar coordinates of reference space vector V_{REF}*). The inverter generates the modulated phase voltages V_{U}, V_{V}, V_{W} which are supplied to the motor 100. For controlling the angular velocity of the motor 100, the three resulting phase currents i_{U}, i_{V}, i_{W} may be measured. In some applications, the angular position θ_{S} of the rotor is measured, e.g. using a rotary encoder or the like.

In the present example, the measured values of the phase currents i_{U}, i_{V}, i_{W} are subjected to a coordinate transformation commonly referred to as Clarke-Park transform (Clark transform and subsequent Park transform). Clark and Park transform can be combined into one transformation step, and the corresponding functional block is labelled 220 in FIG. 1. The Clarke-Park transform 220 generates the orthogonal current signals i_{d} and i_{q}. The axes of the corresponding Cartesian coordinate system are often labeled d and q and, therefore, the Park transform is also referred to as d/q transform. The current signals i_{d} and i_{q} are supplied to the controller 230, which receives corresponding set-point values V_{d,SET} and V_{q,SET}.

The controller 230 generates the output signals V_{d} and V_{q} based on the current signals i_{d} and i_{q} and the set-point values V_{d,SET} and V_{q,SET}. The controller output signals V_{d} and V_{q} are subject to an inverse Park transform resulting in corresponding voltage signals V_{α} and V_{β} (not shown in FIG. 1) wherein the subscripts α and β represent the axes of a Cartesian coordinate system in the rotating reference frame. The voltage signals V_{α} and V_{β}, which represent the mentioned reference space vector V_{REF}* in the Cartesian coordinate system α/β, are subsequently transformed into polar coordinates to obtain amplitude V_{REF} and angle θ, which are the input parameters for the space vector modulator. The functional block including the inverse Park transform and the coordinate transformation into polar coordinates is labelled 210 in FIG. 1. In some implementations, the function blocks 210 and 220 may use the measured angular position θ_{S} of the rotor as input parameter.

The concept illustrated by the control loop in FIG. 1 is commonly known as vector control or field-oriented control (FOC) and is therefore not further discussed herein in more detail. For the further discussion, however, it is important that the functional block 200 and in particular the inverter is supplied by a bipolar voltage supply, e.g. by the positive supply voltage +U_{P} and the negative supply voltage −U_{N} with respect to reference voltage of a so-called neutral node n₀ (neutral point) which may be defined as zero volts without loss of generality. The bipolar voltage supply is provided by two batteries (or two battery modules each including a plurality of batteries) which are connected in series at the neutral node n. As the state of charge (SoC) of the two batteries (labelled “battery 1” and “battery 2” in FIG. 1) is not necessarily identical, the bipolar voltage supply may be unsymmetrical with respect to the electric potential of the neutral node n₀ (i.e. U_{P}≠U_{N}).

FIG. 2 illustrates functional block 200 in more detail. Accordingly, the functional block 200 includes the inverter 202 and the space vector modulator 201, which usually uses a PWM switching scheme to control the inverter operation. As shown in FIG. 2, the inverter 202 receives—from the space vector modulator 201—a plurality of gate signals supplied to the control electrodes of the transistors included in the inverter 202, and the inverter 202 generates the corresponding modulated phase voltages Vᵤ, V_{V}, V_{W} for the 3-phase motor 100. It is noted that in some applications more than three phases may be used. As mentioned before, the inverter 202 is supplied by a bipolar supply (voltages+Uₚ and −U_{N} with respect to the neutral point voltage, which may be defined as 0V), and the supply voltages+U_{P} and −U_{N} may be unsymmetrical with respect to the neutral point due to different states of charge of the batteries. The parameter p may be used to quantify the degree of asymmetry of the bipolar supply. In the present example the parameter p is defined as the ratio U_{N}/U_{DC}, wherein U_{D}C denotes the sum of the supply voltages U_{P}+U_{N}. Accordingly, the supply voltages can also be expressed as U_{N}=ρ·U_{DC} and Uₚ=(1−ρ·U_{DC}, wherein the parameter ρ may (theoretically) vary between 0 and 1 (ρ=0 indicates U_{N}=0, ρ=1 indicates U_{P}=0). Accordingly, ρ is referred to as symmetry parameter that quantitatively describes the symmetry (or lack of symmetry/asymmetry) of the power supply.

The circuit shown in FIG. 2 further includes a battery monitoring circuit 203 configured to monitor the positive supply voltage Uₚ and the negative supply voltage U_{N} with respect to a neutral node n₀ of a battery. The battery monitoring circuit 203 may provide any signal or parameter that represent the battery voltages U_{P} and U_{N}, for example a measured U_{DC} representing the sum U_{P}+U_{N} and the parameter ρ described above. Other signals or parameters may be used dependent on the actual implementation. The parameters U_{D}C and ρ may be communicated to the space vector modulator 201 in any known manner, for example using a digital bus such as CAN (Controller Area Network) or any other suitable communication link. In another example, analog voltage signals representing U_{P} and U_{N} may be supplied to the space vector modulator 201.

Furthermore, the circuit of FIG. 2 includes the inverter 202 which is configured to provide a plurality of modulated phase voltages that represent a reference voltage vector V_{REF} (amplitude V_{REF} and angle θ in polar coordinates). The space vector modulator 201 is configured to generate modulated drive signals for the inverter 202 based on the reference voltage vector V_{REF}*. In the examples described herein PMW switching schemes are used. In case the inverter 202 is composed of Metal-on-Semiconductor (MOS) field-effect transistors (MOSFETs), the mentioned drive signals are the gate voltages supplied to the gates of the MOSFETs. Each drive signal (gate signal) has is modulated in accordance with a duty cycle. In the examples described herein the duty cycles of the modulated drive signals depend on the monitored positive supply voltage U_{P} and the monitored negative supply voltage −U_{N}. In the example depicted in FIG. 2, the duty cycles of the modulated drive signals depend on the total DC voltage U_{D}C and the parameter ρ (which together unambiguously represent U_{P} and −U_{N} and thus convey the same information as the voltages U_{P} and −U_{N}).

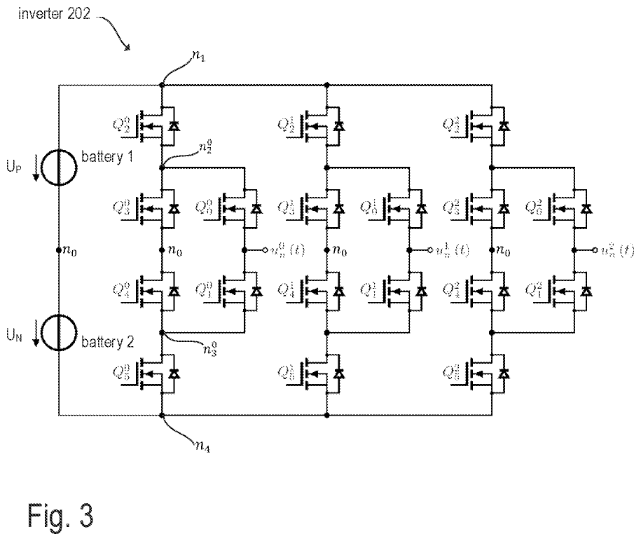

FIG. 3 illustrates one exemplary embodiment of the inverter 202. According to FIG. 3, the inverter is composed of three phases, wherein each phase is implemented by a corresponding branch of the inverter. As mentioned, the inverter may have more than three phases in other embodiments. The batteries labelled “battery 1” and “battery 2” are represented by voltage sources in the depicted example, wherein the voltage sources are electrically connected at the neutral point no.

Each one of the three branches of the inverter of FIG. 3 comprises six MOSFETs denoted Qᵢ^{p}, wherein the superscript p (p=0, 1, 2) indicates the phase/branch and the subscript i (i=0, . . . 5) denotes a specific transistor of a specific phase/branch. In each branch p, the transistors Q₂^{p}, Q₀^{p}, Q₁^{p}, and Q₅^{p} form a chain (series circuit) between the positive supply node n₁ (at which voltage U_{P} is provided) and the negative supply node n₄ (at which voltage −U_{N} is provided). In this context “chain of transistors” or a series circuit of two or more transistors means that the main current paths (drain-source current paths) of the transistors are electrically connected in series (one after another). That is, for the first branch p=0, transistor Q_{Z}⁰ is connected between positive supply node n₁ and circuit node n₂⁰, transistor Q₀⁰ is connected between circuit node n₂⁰ and the phase output node n₂⁰, transistor Q₀⁰ is connected between phase output node n₂⁰ and circuit node nₓ⁰, transistor Q₁⁰ is connected between circuit node n₃⁰ and the negative supply node n₄. Between the circuit nodes n₂⁰ and n₃⁰ a series circuit of the two further transistors Q₃⁰ and Q₄⁰ is connected in parallel to the series circuit of transistors Q₀⁰ and Q₁⁰, wherein the common circuit node between transistors Q₃⁰ and Q₄⁰ is connected to the neutral node n₀. The other branches of the inverter (p=1 and p=2) are constructed analogously to the first branch (p=0).

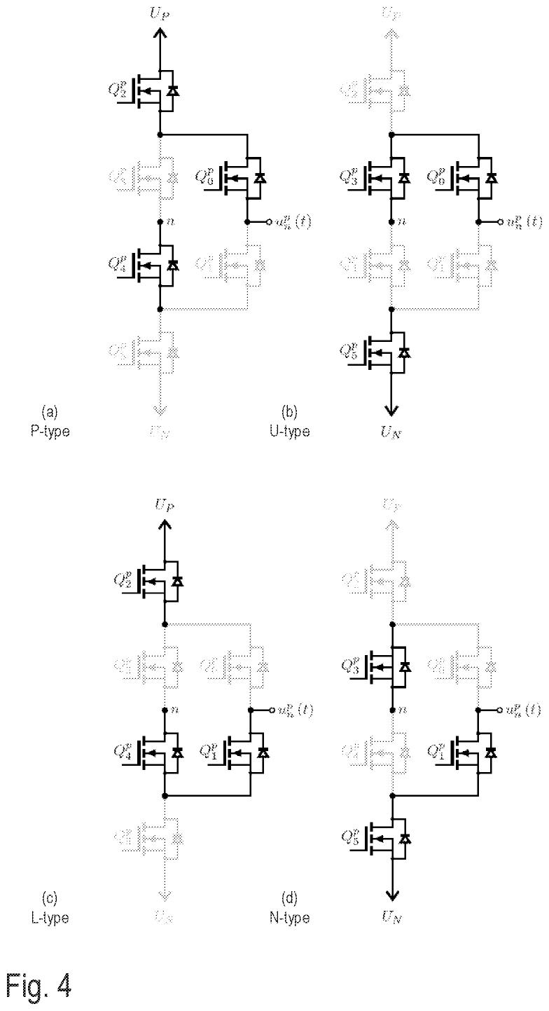

In the examples described herein, each phase p of the inverter can assume one of four states that are referred to as P-type state, U-type state, L-type state and N-type state. These four states are illustrated in FIG. 4, diagrams (a) to (d), wherein in each depicted state the transistors shown greyed out are inactive (off) while the other transistors are active (on).

In the P-type state, the transistors Q₂^{p}, Q₀^{p} and Q^{p} are switched on, while the other transistors Q₁^{p}, Q₃^{p} and Q₅^{p} are switched off. As a result, the phase voltage at output node nₓ^{p} equals the positive supply voltage U_{P} when neglecting the voltage drop across the conductive transistors. This situation is represented by diagram (a) of FIG. 4.

In the U-type state, the transistors Q₀^{p}, Q₃^{p} and Q₅^{p} are switched on, while the other transistors Q₁^{p}, Q₂^{p} and Q₄^{p} are switched off. As a result, the phase voltage uₙ^{p}(t) at output node nₓ^{p} equals to the neutral point voltage (0V). This situation is represented by diagram (b) of FIG. 4, which shows that the output node nₓ^{p} is actively connected to the neutral node n₀ via transistors Q₃^{p} and Q₀^{p}.

In the L-type state, the transistors Q₁^{p}, Q₂^{p} and Q₄^{p} are switched on, while the other transistors Q₀^{p}, Q₃^{p} and Q₅^{p} are switched off. Accordingly, the L-type state is complementary to the U-type state. Again, the phase voltage uₙ^{p}(t) at output node nₓ^{p} equals to the neutral point voltage (0V). This situation is represented by diagram (c) of FIG. 4, which shows that the output node nₓ^{p} is actively connected to the neutral node n₀ via transistors Q₄^{p} and Q₁^{p}.

In the N-type state, the transistors Q₁^{p}, Q₃^{p} and Q₅^{p} are switched on, while the other transistors Q₂^{p}, Q₀^{p} and Q₄^{p} are switched off. Accordingly, the N-type state is complementary to the P-type state. As a result, the phase voltage at output node nₓ^{p} equals the negative supply voltage −U_{N}. This situation is represented by diagram (d) of FIG. 4.

In the above discussion, the voltage drops across active transistors is assumed to be negligible. The states P, U, L, and N of a specific branch p of the inverter have been discussed with reference to FIG. 4. Similarly, the state of a three-phase inverter can be expressed by triples such as LNN, LUN, PUN, PUU, PUN, etc. In the examples described herein, the only admissible state transitions in a specific branch p of an inverter are P<↔L, N↔U and L↔U, whereas transitions between a P-type state and a U-type state are avoided as well as transistions between an N-type state and an L-type state. Accordingly, the state LUN means that the phase p=0 has an L-type state, the phase p=1 has a U-type state, and the phase p=2 has an N-type state, to give just an example. In case of a 4-phase inverter, the state would be expressed by a quadruple such as LUNP, and by an n-tupel in case of an n-phase inverter (with an integer n>1).

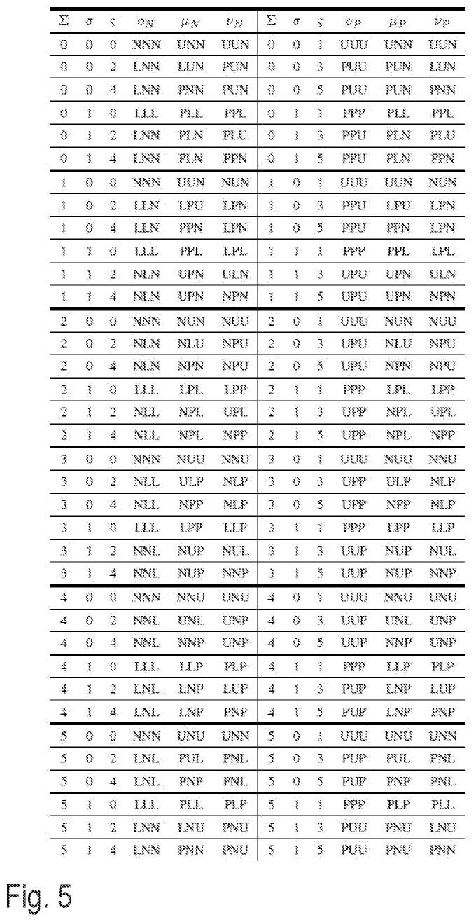

In order to generate a specific output, the space vector modulator 201 (cf. FIG. 2) repetitively generates a specific sequence of states referred to as “modulation sequence”, wherein each state is active for specific time. FIG. 5 shows a table with 72 different modulation sequences, wherein each line of the table represents a specific sequence of switching states of the inverter. In this description, a modulation sequence is be denoted as o_{N}, μ_{N},v_{N}, Nₚ, μₚ, vₚ, wherein each of the switching states o_{N}, μ_{N}, etc. represents a tripel such as LNN, LUN, etc. The variables Σ, σ, and ç which identify a specific sequence included in the table is discussed later.

The output of the inverter 202 (cf. FIG. 2) is determined by the reference voltage V_{REF} and the associated angle θ. The space vector modulator 201 is configured to generate the modulated drive signals (e.g. gate signals) for the transistors included in the inverter 202 (cf. FIG. 3) such that the inverter 202 runs through a desired sequence of inverter states (switching states of the inverter, see table of FIG. 5) within one cycle period denoted as T_{PWM}. The desired modulation sequence is based on the reference voltage vector (magnitude V_{REF} and angle θ) received by the space vector modulator 201.

The mentioned “selection” of the modulation sequence and the associated timing of the inverter states are controlled by the space vector modulator 201. Accordingly, the space vector modulator 201 is configured to generate the modulated drive signals such that—within one cycle period—each inverter state of the selected modulation sequence is active for a specific on-time. In the embodiments described herein, the on-times of the individual inverter states (referred to as o_{N}, μ_{N}, v_{N}, oₚ, μₚ, and vₚ in FIG. 5) are determined by the duty cycles of the drive signals output by the space-vector modulated 201 and supplied to the transistors included in the individual phases/branches of the inverter 202.

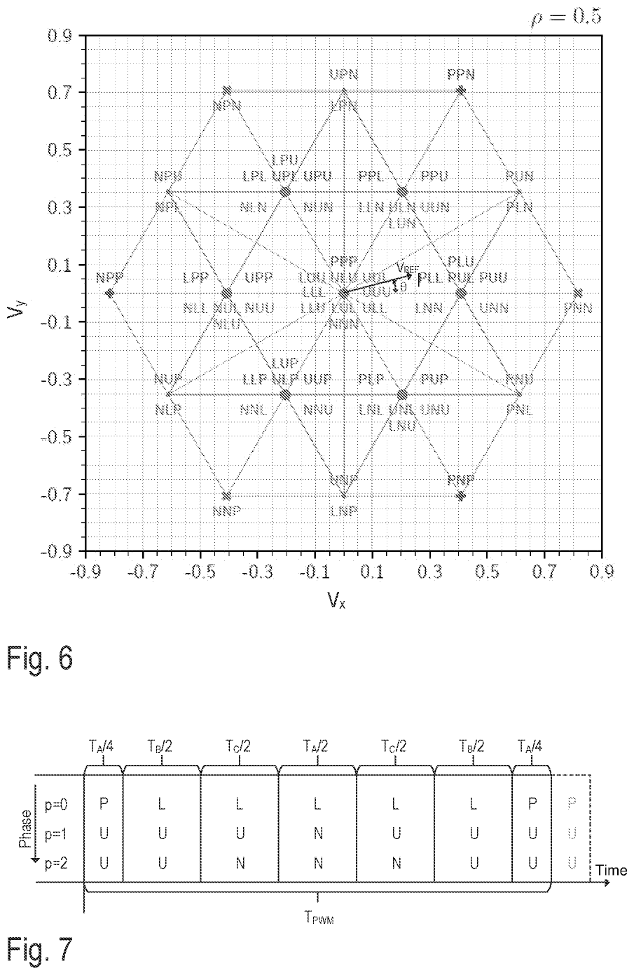

FIG. 6 visualizes the different voltage vectors (space vectors in Cartesian coordinates) that may be generated by the inverter states listed in the table of FIG. 5. FIG. 6 can also be regarded as a visualization of the Clarke transform which maps the three voltages V_{U}=uₙ⁰ (t), V_{V}=uₙ¹(t), and V_{W}=uₙ¹(t) output by the inverter (i.e. each inverter state inverter state) to a corresponding space vector in Cartesian coordinates. At his point of the discussion, it is important to understand that the diagram of FIG. 6 represents a situation, in which the power supply of the inverter is symmetric. That is, the supply voltages Uₚ and U_{N} are equal and the symmetry parameter ρ equals 0.5.

Any triple of inverter output voltages (phase voltages) (V_{U}, V_{V}, V_{W}) may be regarded as a 3×1 vector which can be transformed into the Cartesian coordinate system according to the following transformation (Clarke Transformation):

$$( \begin{matrix}{V}_{x} \\ {V}_{y}\end{matrix} ) = ( \begin{matrix}1 & - 1 / 2 & - 1 / 2 \\ 0 & \sqrt{3} / 2 & - \sqrt{3} / 2\end{matrix} ) ( \begin{matrix}{V}_{U} \\ {V}_{V} \\ {V}_{W}\end{matrix} ) .$$

It is noted, however, that the x- and y-coordinates as shown in FIG. 6 are normalized and such the x- and y-axes are not in volts but dimensionless.

In Cartesian coordinates, the states that can be generated by a three-level three-phase inverter as depicted in FIG. 3 are all located either on the vertices of an inner (smaller) hexagon, on the vertices of an outer (larger) hexagon or on the center points of the edges of the outer hexagon (i.e. in the middle between two neighboring vertices). In total, 19 different voltage vectors can be generated, namely the zero vector in the center, six vectors with end points on the vertices of the inner hexagon, six with end points on the vertices of the outer hexagon and six with end points on the edges of the outer hexagon. It is evident from FIG. 6, than different inverter states may result in the same vector in Cartesian coordinates. For example, the inverter states PPP, NNN, UUU, LLL, LUU, ULU, UUL, ULL, LUL, and LLU all result in the zero vector. Similarly, the inverter states LNN, UNN, PLL, PUL, PLU and PUU all result in the vector denoting the rightmost vertex of the inner hexagon. Only the six states PPN, NPN, NPP, NNP, PNP and PNN unambiguously represent the six vectors denoting the six vertices of the outer hexagon shown in FIG. 6. It is noted that the scale of the x- and y-axis of the diagram of FIG. 6 is normalized and is not important for the present discussion. Each state (and thus each vertex) shown in FIG. 6 represents a voltage (expressed in Cartesian coordinates or as magnitude and angle) that can be generated by the inverter at its output.

FIG. 6 also includes an exemplary reference voltage vector (magnitude V_{REF}, angle θ). This reference voltage may be represented by a modulation sequence which includes inverter states associated with the adjacent vertices of the triangle that encloses the end point of the reference vector. In the example of FIG. 6, the reference vector may be represented by the modulation sequence PUU, LUU, LUN, LNN, LUN, LUU. This sequence is not included in the table of FIG. 5, which shows that table of FIG. 5 is rather an example and not the only option to select the modulation sequences. In the present example, the space vector modulator 201 determines times T_{A}, T_{B}, and T_{C}, wherein the time T_{A} is associated with the states PUU and LNN (which are equivalent in the sense that both are mapped to the same space vector/vertex), the time T_{B} is associated with the state LUU (which occurs twice in the mentioned modulation sequence), and the time T_{C} is associated with the state LUN (which also occurs twice).

The timing of the above-mentioned modulation sequence is visualized in the diagram of FIG. 7. The two occurrences of the state LUU each have a duration of T_{B}/2, the two occurrences of the state LUN each have a duration of T_{B}/2, the state LNN has a duration of T_{A}/2, and the equivalent state PUU is (temporally) split in two parts. The first part is at the beginning of the sequence and the second part at the end of the sequence and each part having a length of T_{A}/4. The sum T_{A}+T_{B}+T_{C} equals the PWM cycle time T_{F}WM. The times T_{A}, T_{B}, and T_{C} unambiguously determine the duty cycles of the drive signals which control the switching operation of the transistors included in the inverter.

As can be seen from FIG. 6, the specific modulation sequence PUU, LUU, LUN, LNN, LUN, LUU, (PUU) can be selected purely based on the reference voltage vector V_{REF}*. For selecting a suitable sequence of inverter states, the space vector modulator merely needs to determine the three adjacent vertices of the triangles which compose the hexagons of FIG. 6. The times T_{A}, T_{B}, T_{C} associated with the states are calculated also purely based on the reference voltage vector V_{REF}* and the inverter states included in the selected sequence. Algorithms for calculating the times T_{A}, T_{B}, T_{C} are as such known and thus not discussed herein in great detail. Basically, the times can be obtained by calculating barycentric coordinates for the reference vector V_{REF}* using the voltages represented by the three vertices represented by the selected sequence. As mentioned, PUU and LNN represent the same (first) vertex and LUU and LUN represent the second and third vertices relevant for the modulation sequence currently considered.

The reference vector V_{REF}* is the only (non-constant) input parameter, which affects the selection of the modulation sequence and the calculation of the times associated with the inverter states of the selected sequence. As mentioned, FIG. 6 and the above explanation is based on the assumption of a symmetric power supply of the inverter, which is usually the case in conventional systems, in which the DC bus voltage is divided by a one-to-one capacitive voltage divider to obtain the neutral point voltage. However, the situation is somewhat more complicated when the power supply of the inverter 202 is unsymmetrical (i.e. ρ≠0.5).

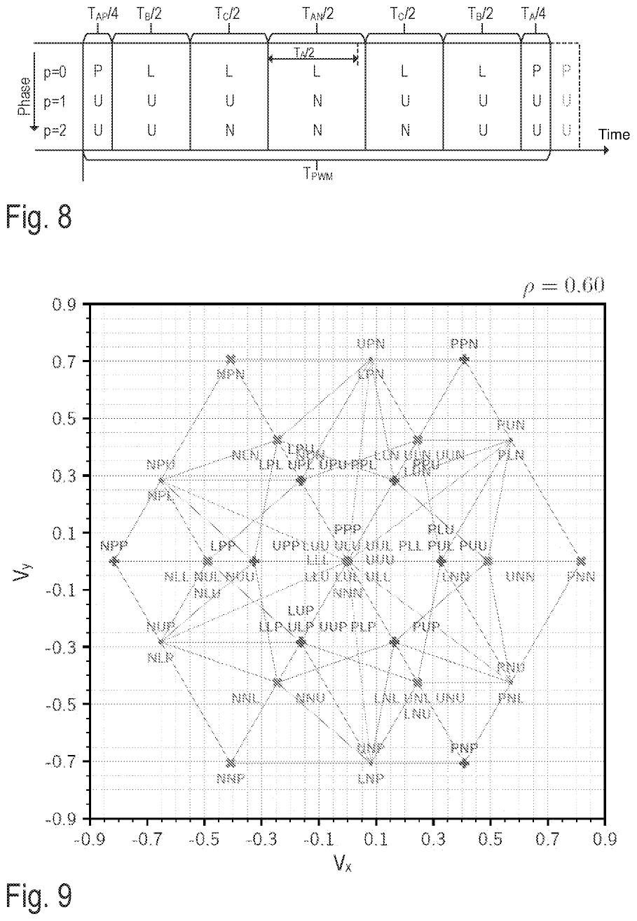

In a first approach the selection of the modulation sequence is made as explained above (as if the power supply was symmetric). Also the times T_{A}, T_{B}, and T_{C} can be determined as explained above (e.g. using the barycentric method). However, the time T_{A}, which is used for the states PUU an LNN in the example of FIG. 7, is now modified dependent on the supply voltages Uₚ and U_{N}, for example, dependent on the symmetry parameter ρ). An example is shown in FIG. 8.

FIG. 8 is a diagram illustrated the modified timing of the above-mentioned modulation sequence dependent on the actually measured asymmetry of the power supply. FIG. 8 is almost the same as FIG. 7, except that the time T_{A} has been changed to T_{AP} for state PUU and to T_{AN} for state LNN, wherein T_{AN}=T_{A}+Δ_{T} and T_{AP}=T_{A}−Δ_{T} so that the total PWM cycle time is unchanged. This modification does not affect the output voltage of the inverter when averaged over one cycle, because the states PUU and LNN represent the same represent the same voltage vector (cf. FIG. 6, PUU and LNN are associated with the same vertex). However, as can be seen from FIGS. 3 and 4, the state PUU will couple the load to the first battery (providing U_{P}) whereas the state LNN will couple the load to the second battery (providing −U_{N}), while both states represent the same vertex. Accordingly, a positive Δ_{T} will increase the time for state LNN and reduce the time for state PUU, while the total time for the respective vertex is unchanged.

Therefore, in a situation, in which the SoC of the first battery is lower than the SoC of the second battery (i.e. ρ>0.5, U_{N}>U_{P}), then Δ_{T} may be set to positive time values to couple to first battery less time to the load (and the second battery more time). Conversely, in a situation, in which the SoC of the first battery is higher than the SoC of the second battery (i.e. ρ<0.5, U_{N}<U_{P}), then Δ_{T} may be set to negative time values to couple the first battery more time to the load (and the second battery less time). The time difference Δ_{T} may be increased to higher positive or negative values, when the deviation of ρ from its ideal value of 0.5 increases or decreases, respectively. If the SoC of both batteries is approximately equal (e.g. ρ∈[0.5−ε, 0.5+ε] with ε being a small positive value), then Δ_{T} may be set to zero.

The concept discussed above has been explained by reference to the exemplary modulation sequence of FIGS. 7 and 8, which is valid for a reference vector V_{REF}* whose end point lies in the first triangle/segment (between θ=0° and θ=60°) of the inner hexagon. However, as can be seen in FIG. 6, this concept can be applied to all triangles/segments that compose the hexagons of FIG. 6. It is noted that this concept helps to stabilize the symmetry of the power supply as it allows to source more power from the battery with the higher SoC than from the battery with the lower SoC. In a system, in which one or more single-phase loads source power from only one of the batteries, the bipolar power supply provided by the two batteries together will always become unsymmetrical. Operating a three-phase load as described above will help to rebalance the supply or to at least reduce its asymmetry. Moreover, a runaway condition, which causes the battery with the lower SoC being discharged even more than the other battery can be avoided.

In other words the space vector modulator 201 is configured to generate the modulated drive signals for the inverter 202 such that, within one cycle period T_{PWM}, each switching state (see FIG. 5, states o_{N}, μ_{N}, v_{N}, oₚ, μₚ, vₚ) of the desired modulation sequence is active for a specific on-time (see also FIG. 13, on-times T_{N}⁰, T_{N}¹, T_{N}², Tₚ⁰, Tₚ¹, Tₚ²). The actual on-times of the switching states are determined by the duty cycles of the drive signals, and the drive signals are generated based on the on-times determined by the space vector modulator 201. In the example depicted in FIGS. 7 and 8, the desired modulation includes first states (see FIG. 5, states o_{N}, μ_{N}, v_{N}) and second states (see FIG. 5, states oₚ, μₚ, vₚ), wherein the first states cause the inverter to generate a positive average load current during one cycle T_{PWM} (thus coupling the load—on average—more to the first battery) and the second states cause the inverter to generate a negative average load current during one cycle T_{PWM} (thus coupling the load—on average—more to the second battery). Using the present approach, the space vector modulator 201 controls the duty cycles of the modulated drive signals such that the cumulated on-times of the first states is larger than the cumulated on-times of the second states when the positive supply voltage Uₚ has a higher magnitude than the negative supply voltage −U_{N} and vice versa.

In the example above, the selection of the modulation sequence was done based on the reference vector V_{REF}* under the assumption of a symmetric power supply. That is, the space vector modulator is basically operated as if the power supply was symmetric, and only the timing of the sequence is modified as explained above with reference to FIGS. 7 and 8. This approach helps to keep the power supply in an approximately balanced state and may even be used to rebalance an unsymmetrical power supply. However, the above-mentioned approach does not consider the fact that the actual average voltage vector generated by the inverter (averaged over one cycle) does not precisely match the reference vector V_{REF}* if the power supply is unsymmetrical. As a result, the DC component may differ from zero and higher harmonics may be generated. The approach described below allows a precise three-phase operations of the inverter at unsymmetrical bipolar power supplies, even if the asymmetry is significant.

As mentioned FIG. 6 illustrates a situation in which the power supply of the inverter is symmetric (i.e. U_{P}=U_{N}, ρ=0.5). When, for some reason, the symmetry parameter ρ increases to values greater than 0.5 or decreases to values lower than 0.5, then the inner hexagon of FIG. 6 will be distorted. FIG. 9 illustrates the situation for ρ=0.6, which means that the voltage U_{N} of the second battery is 1.5 times the voltage U_{P} of the first battery. The inner hexagon in FIG. 6 are in fact two congruent hexagons whose congruence is also destroyed for ρ≠0.5. Accordingly, inverter states (e.g. PLL and LNN), which generate the same voltage vector according to FIG. 6, do not anymore result in the same voltage vector. Moreover, the voltage vectors that have their end points on the edges of the outer hexagon (which is not distorted) will move from the center point between two vertices towards one of the adjacent vertices for ρ>0.5 or ρ<0.5.

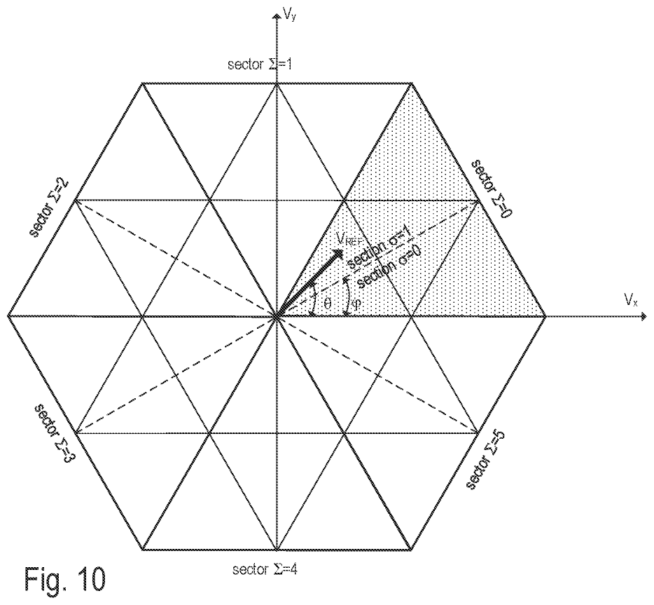

FIGS. 10-12 illustrate the decomposition of the hexagon of the diagram of FIG. 6 into sectors Σ, sections σ and segments ζ for the purpose of selecting a suitable modulation sequence for a specific reference vector V_{REF}* and calculating the times associated with the inverter states of the selected sequence. To keep the illustration simple, FIG. 10-12 illustrates the situation for ρ=0.5 (undistorted inner hexagon). However, the following approach is generic and also application to situations in which the symmetry parameter ρ is greater or lower than 0.5.

FIG. 10 is equivalent to the diagram of FIG. 6. The outer hexagon is regularly divided into six triangles referred to as sectors Σ. The voltage vectors that have their end-points on the vertices of the outer hexagon (which is not distorted for ρ≠0.5) have angles of 0°, 60°, 120°, 180°, 240° and 300°. Any reference vector V_{REF}* is in sector E if the angle θ of the vector V_{REF} is in the interval [π·π/3, (Σ+1)·π/3[. In other words, sector Σ=0 extends from 0 to π/3 rad (60°), sector Σ=1 extends from π/3 to 2π/3 rad (120°), etc.

As can be seen in FIG. 10, each sector Σ can be divided into two sections σ, wherein section σ=0 is located at lower angles and the section σ=1 is located at higher angles. Although, in FIG. 10, the sections σ=0 and σ=1 have equal size, this is not necessarily the case in a general situation in which ρ≠0.5. In the asymmetric case illustrated in FIG. 9, the section σ=0 is larger than section σ=1 in sector Σ=0, whereas the opposite is true for sector Σ=1. The angle, at which a sector is divided into the two sections σ=0 and σ=1, is denoted as φ in FIG. 10, wherein φ is different in each sector Σ and depends on the supply voltages U_{P}, U_{N}.

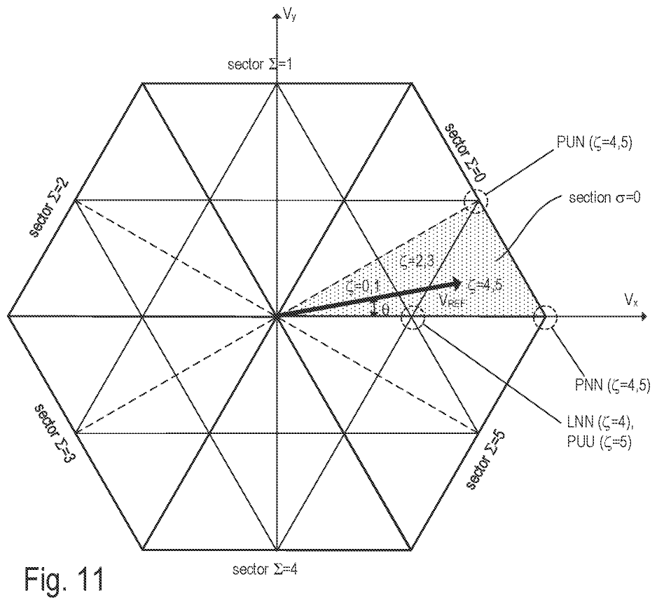

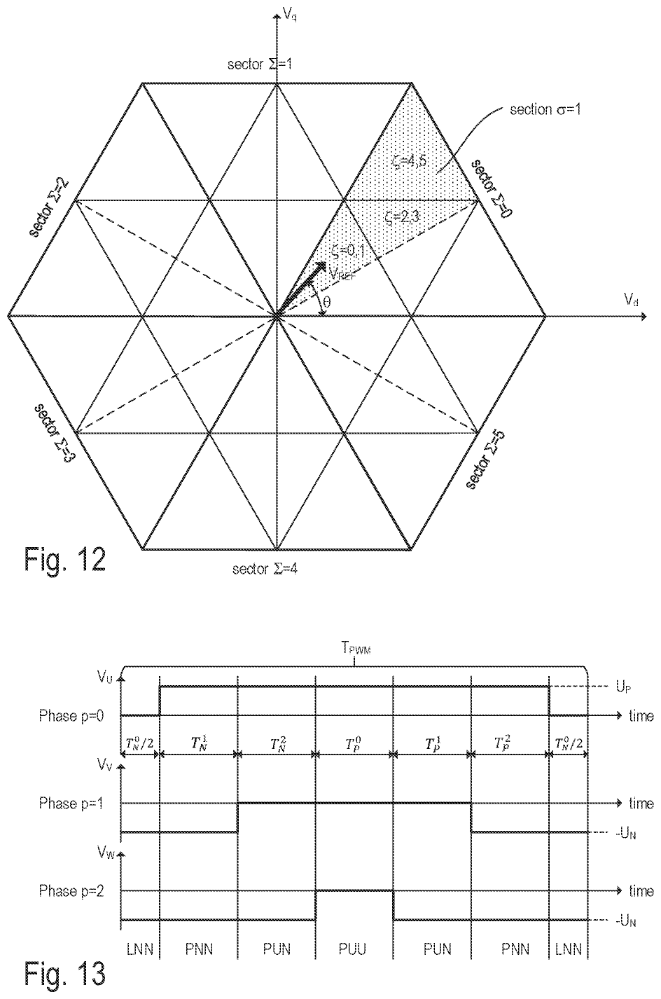

Each section a of a sector Σ is associated with six segments ζ (i.e. ζ=0, 1, . . . , 5) which are illustrates in FIGS. 11 and 12. In FIG. 11, the shaded area of the diagram indicates section σ=0 of sector Σ=0. The segments associated with section σ=0 are the triangles labelled in FIG. 11 as ζ=0,1, ζ=2,3, and ζ=4,5, respectively. As mentioned above, in the symmetric case, some inverter states result in the same voltage vectors. Accordingly, segments ζ=0 and ζ=1 are congruent as well as segments ζ=2 and ζ=3 and segments ζ=4 and ζ=5. However, in the asymmetric case (ρ≠0.5) the congruence is destroyed as can be seen in FIG. 9. Nevertheless, segments that are congruent in the symmetric case may partly overlap in the asymmetric case.

In FIG. 12, the shaded area of the diagram indicates section σ=1 of sector Σ=0. The segments associated with section σ=1 are the triangles labelled in FIG. 12 as ζ=0,1, ζ=2,3, and ζ=4,5, respectively. Again, segments ζ=0 and ζ=1 are congruent as well as segments ζ=2 and ζ=3 and segments ζ=4 and ζ=5. The segments in FIGS. 11 and 12 are basically the four triangles that form one sector Σ. Each vertex is the end point of a voltage vector (Vₓ, V_{y}) that corresponds to one or more inverter state (V_{U}, V_{V}, V_{W}).

To select a specific modulation sequence, the space-vector modulator 201 needs to determine in which segment (identified by Σ, σ, and ζ) the end point of the reference voltage vector V_{REF}* lies. Geometrically, this determination is self-evident. The space-vector modulator 201 can make this determination by calculating barycentric coordinates for the reference vector V_{REF}* using the voltage vectors represented by the three vertices of each segment ζ (barycentric method). If the correct segment is found, this method also yields the times associated with the inverter states that correspond to the respective vertices. The mathematics behind the problem of determining whether a point lies within a triangle is as such well-known and thus not further discussed herein in more detail.

One result of the decomposition of the outer hexagon in FIGS. 10-12 into sectors E, sections σ, and segments ζ is summarized in the table of FIG. 5 which has already be discussed above. Six sectors each having two sections each of which being associated with six segments result in 72 possible combinations listed in the table of FIG. 5. However, as discussed above, the segments ζ=0 and ζ=1 are overlap, as well as segments ζ=2 and ζ=3 and segments ζ=4 and ζ=5. Therefore, one modulation sequence is composed of the sub-sequences associated with two overlapping segments. In FIG. 5, each line includes one of 36 modulation sequences, wherein the first sub-sequence (of three inverter states) of each sequence is associated with segments ζ=0, 2, or 4 and the second sub-sequence (of three inverter states) of each sequence is associated with segments ζ=1, 3, or 5. Together, the two sub-sequences include six inverter states which form one modulation sequence.

FIG. 11 illustrates one example, in which the reference vector V_{REF}* has an end-point in segments ζ=4 and ζ=5 in the lower section σ=0 of the first sector Σ=0. These parameters Σ, σ, ζ identify the modulation sequence LNN, PNN, PUN, PUU, PUN, PNN in the third line of the table in FIG. 5. During the modulation sequence, the inverter output jumps between the vertices of the triangles represented by segments ζ=4 and ζ=5 (which are congruent in FIG. 11 but only partially overlap in a general case as shown in FIG. 9). The resulting switching pattern is further illustrated by the timing diagrams of FIG. 13, in which the first state LNN has again split into two halves as in the previous examples of FIGS. 7 and 8.

As all vertices in FIG. 11 except those of the outer hexagon depend on the supply voltages U_{P} and U_{N}, it is evident that the on-times T_{N}⁰, T_{N}¹, T_{N}², T_{P}⁰, T_{P}¹, T_{P}² shown in FIG. 13 which the barycentric method yields, also depend on the supply voltages Uₚ and U_{N} (and thus on the parameter ρ). As a result, the duty cycles of the drive signals generated by the space vector modulator 201 for the transistors of the inverter 202 also depend on the supply voltages Uₚ and U_{N}.

Although the invention has been illustrated and described with respect to one or more implementations, alterations and/or modifications may be made to the illustrated examples without departing from the spirit and scope of the appended claims. In particular regard to the various functions performed by the above described components or structures (units, assemblies, devices, circuits, systems, etc.), the terms (including a reference to a “means”) used to describe such components are intended to correspond—unless otherwise indicated—to any component or structure, which performs the specified function of the described component (e.g., that is functionally equivalent), even though not structurally equivalent to the disclosed structure, which performs the function in the herein illustrated exemplary implementations of the invention.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in anyway.

Finally, it is the applicant's intent that only claims that include the express language “means for” or “step for” be interpreted under 35 U.S.C. § 112. Claims that do not expressly include the phrase “means for” or “step for” are not to be interpreted under 35 U.S.C. 112.

What is claimed is:

1. A circuit comprising:
a battery monitoring circuit configured to monitor a positive supply voltage and a negative supply voltage with respect to a neutral node;
an inverter configured to provide a plurality of modulated phase voltages representing a reference voltage vector; and
a space vector modulator configured to generate modulated drive signals for the inverter based on the reference voltage vector, wherein duty cycles of the modulated drive signals depend on the monitored positive supply voltage and the monitored negative supply voltage.

2. The circuit of claim 1 further comprising:
a first battery and a second battery connected to the neutral node and configured to provide the positive supply voltage and the negative supply voltage.

3. The circuit of claim 1, wherein the inverter is an active-neutral-point-clamped (ANPC) multi-level converter.

4. The circuit of claim 3, wherein:
the ANPC multi-level converter includes three phases, each phase of the three phases being coupled between a first supply node and a second supply node and configured to receive a DC supply voltage corresponding to a difference between the positive supply voltage and the negative supply voltage, and
each phase of the three phases is configured to provide a respective one of the three phase voltages by outputting either the positive supply voltage, the negative supply voltage or a neutral point voltage dependent on a switching state of the ANPC multi-level converter.

5. The circuit of claim 1, wherein the space vector modulator is configured to generate the modulated drive signals such that the inverter runs through a selectable modulation sequence of switching states within one cycle period, and the selectable modulation sequence is configured to be selected based on the reference voltage vector.

6. The circuit of claim 5, wherein:
the space vector modulator is configured to generate the modulated drive signals such that, within one cycle period, each switching state of the selectable modulation sequence is active for a specific on-time;
the on-times of the switching states are configured to be determined based on the duty cycles of the drive signals; and
the duty cycles of the drive signals are configured to depend on the monitored positive supply voltage and the monitored negative supply voltage.

7. The circuit of claim 5, wherein:
the selectable modulation sequence includes first states and second states;
the first states are configured to cause the inverter to generate a positive average load current during a cycle in which the first states are active; and
the second states are configured to cause the inverter to generate a negative average load current during a cycle in which the second states are active.

8. The circuit of claim 7, wherein:
the space vector modulator is configured to control the duty cycles of the modulated drive signals such that cumulative on-times of the first states is larger than cumulative on-times of the second states in response to the positive supply voltage having a higher magnitude than the negative supply voltage; and
the space vector modulator is configured to control the duty cycles of the modulated drive signals such that the cumulative on-times of the second states is larger than the cumulative on-times of the first states in response to the positive supply voltage having a lower magnitude than the negative supply voltage.

9. A method comprising:
monitoring a positive supply voltage and a negative supply voltage of an inverter with respect to a neutral node;
generating, by a space vector modulator, modulated drive signals for the inverter based on a reference voltage vector, wherein duty cycles of the modulated drive signals depend on the monitored positive supply voltage and the monitored negative supply voltage; and
providing the modulated drive signals to the inverter, wherein the inverter is configured to provide a plurality of modulated phase voltages representing the reference voltage vector in response to the modulated drive signals.

10. The method of claim 9, wherein the inverter is an active-neutral-point-clamped (ANPC) multi-level converter.

11. The method of claim 9, further comprising:
providing the positive supply voltage by a first battery connected to the neutral node; and
providing the negative supply voltage by a second battery connected to the neutral node.

12. A three-level inverter system comprising:
a first power supply connected to a neutral node and configured to supply a positive supply voltage;
a second power supply connected to the neutral node and configured to supply a negative supply voltage;
a battery monitoring circuit configured to monitor the positive supply voltage and the negative supply voltage;
an inverter supplied by the positive supply voltage and the negative supply voltage; and
a space vector modulator configured to generate modulated drive signals for the inverter based on the monitored positive supply voltage and the negative supply voltage, wherein the generated modulated drive signals are configured to cause the positive supply voltage and the negative supply voltage to remain substantially balanced.

13. The three-level inverter system of claim 12, wherein
the inverter is configured to provide a plurality of modulated phase voltages representing a reference voltage vector;
the space vector modulator is configured to generate the modulated drive signals for the inverter based on the reference voltage vector; and
duty cycles of the modulated drive signals depend on the monitored positive supply voltage and the monitored negative supply voltage.

14. The three-level inverter system of claim 12, wherein the inverter is an active-neutral-point-clamped (ANPC) three-level converter.

15. The three-level inverter system of claim 14, wherein
the ANPC three-level converter includes three phases, each phase of the three phases being coupled between a first and a second supply node and configured to receive a DC supply voltage corresponding to a difference of the positive supply voltage and the negative supply voltage; and
each phase of the three phases is configured to provide a respective one of three phase voltages by outputting either the positive supply voltage, the negative supply voltage or a neutral point voltage in response to a switching state of the ANPC three-level converter.

16. The three-level inverter system of claim 12, wherein
the space vector modulator is configured to generate the modulated drive signals such that the inverter runs through a selectable modulation sequence of switching states within one cycle period; and
the selectable modulation sequence is configured to be selected based on a reference voltage vector.

17. The three-level inverter system of claim 12, wherein
the space vector modulator is configured to generate the modulated drive signals such that the inverter runs through a selected modulation sequence of switching states within one cycle period; and
the selectable modulation sequence is configured to determined based on a reference voltage vector such that the positive supply voltage and the negative supply voltage remain substantially balanced.

18. The three-level inverter system of claim 12, wherein
the space vector modulator is configured to generate the modulated drive signals such that, within one cycle period, each switching state of a selectable modulation sequence is active for a specific on-time;
the on-times of the switching states are configured to be determined based on duty cycles of the drive signals; and
the duty cycles of the drive signals depend on the monitored positive supply voltage and the monitored negative supply voltage.
